(19) United States
(12) Patent Application Publication
(10) Pub. No.: US 2017/0103757 A1
(43) Pub. Date: Apr. 13, 2017

(54) SPEECH INTERACTION APPARATUS AND METHOD

(71) Applicant: KABUSHIKI KAISHA TOSHIBA, Tokyo (JP)

(72) Inventors: Ayana Yamamoto, Yokohama Kanagawa (JP); Hiroko Fujii, Komae Tokyo (JP)

(21) Appl. No.: 15/388,806

(22) Filed: Dec. 22, 2016

Related U.S. Application Data
(63) Continuation of application No. PCT/JP2015/059010, filed on Mar. 18, 2015.

(30) Foreign Application Priority Data
Sep. 18, 2014 (JP) 2014-190226

(51) Int. Cl. G10L 15/22; G10L 25/87; G10L 15/18

(52) U.S. Cl. CPC G10L 15/22; G10L 15/1807; G10L 25/87; G10L 15/1815; G10L 2015/223

(57) ABSTRACT

According to one embodiment, a speech interaction apparatus for performing an interaction with a user based on a scenario includes a speech recognition unit, a determination unit, a selection unit and an execution unit. The speech recognition unit recognizes a speech of the user and generates a recognition result text. The determination unit determines whether or not the speech includes an interrogative intention based on the recognition result text. The selection unit selects, when the speech includes the interrogative intention, a term of inquiry from a response sentence in the interaction in accordance with timing of the speech, the term of inquiry being a subject of the interrogative intention. The execution unit executes an explanation scenario including an explanation of the term of inquiry.

### CROSS-REFERENCE TO RELATED APPLICATIONS

This application is a Continuation Application of PCT Application No. PCT JP2015/059010, filed Mar. 18, 2015 and based upon and claiming the benefit of priority from Japanese Patent Application No. 2014-190226, filed Sep. 18, 2014, the entire contents of which are incorporated herein by reference.

### FIELD

Embodiments described herein relate generally to a speech interaction apparatus and method.

### BACKGROUND

A speech interaction system which enables conversation between a user and a machine using unlimited expressions has progressively spread. The interaction system enables interactions based on understanding various words of users, not predetermined commands, and thus can execute interaction scenarios in various situations such as health consultations, product advice, and consultations regarding malfunctions, etc., so as to reply to inquiries from users. In an interaction such as a health consultation, technical terms that are not usually heard, such as disease names and medicine names, often come up.

In such a case, if a user does not correctly understand a term or expression, the user cannot correctly continue the conversation from then on with the interaction system. To deal with the case where a term that is not understood or is unknown comes out in an interaction, there has been a method of repeating a part in response to a user's question when a user wishes to hear the part again in full, for example, because the part could not be heard during a response from the interaction system. This method enables the user to hear the part again.

There has also been a method which enables a user to listen to an explanation of the meaning of a term that the user does not understand in a system response by the user saying to the interaction system “What is XX ?” Accordingly, even if a term unknown to a user is in a system response, the user can understand the meaning of the term and continue the interaction.

### BRIEF DESCRIPTION OF THE DRAWINGS

FIG. 1 is a block diagram showing a speech interaction apparatus according to a first embodiment.

FIG. 2 is a flowchart showing an operation of the speech interaction apparatus according to the first embodiment.

FIG. 3 is a diagram showing an example of the operation of the speech interaction apparatus according to the first embodiment.

FIG. 4 is a block diagram showing a speech interaction apparatus according to a second embodiment.

FIG. 5 is a flowchart showing an operation of the speech interaction apparatus according to the second embodiment.

FIG. 6 is a diagram showing an example of the operation according to the second embodiment, which is performed when a user requires an explanation.

FIG. 7 is a diagram showing an exemplary operation according to the second embodiment, which is performed when a user does not require an explanation.

FIG. 8 is a block diagram showing a speech interaction. apparatus according to a third embodiment.

FIG. 9 is a flowchart showing an operation of a scenario execution unit.

### DETAILED DESCRIPTION

If a user does not understand the meaning of a term even though a response from the interaction system is replayed, the user can never understand the response. When a term which a user wishes to ask about is a term difficult to pronounce or difficult to be correctly recognized by a speech recognition device, it is difficult for the user to say to the interaction system “What is XX?”

In general, according to one embodiment, a speech interaction apparatus for performing an interaction with a user based on a scenario includes a speech recognition unit, a determination unit, a selection unit and an execution unit. The speech recognition unit recognizes a speech of the user and generates a recognition result text. The determination unit determines whether or not the speech includes an interrogative intention based on the recognition result text. The selection unit selects, when the speech includes the interrogative intention, a term inquiry from response sentence in the interaction in accordance with timing of the speech, the term of inquiry being a subject of the interrogative intention. The execution unit executes an explanation scenario including an explanation of the term of inquiry.

Hereinafter, the speech interaction apparatus and method according to the present embodiment will be described in detail with reference to the drawings. In the following embodiments, the elements which perform the same operation will be assigned the same reference symbol, and redundant explanations will be omitted as appropriate.

### First Embodiment

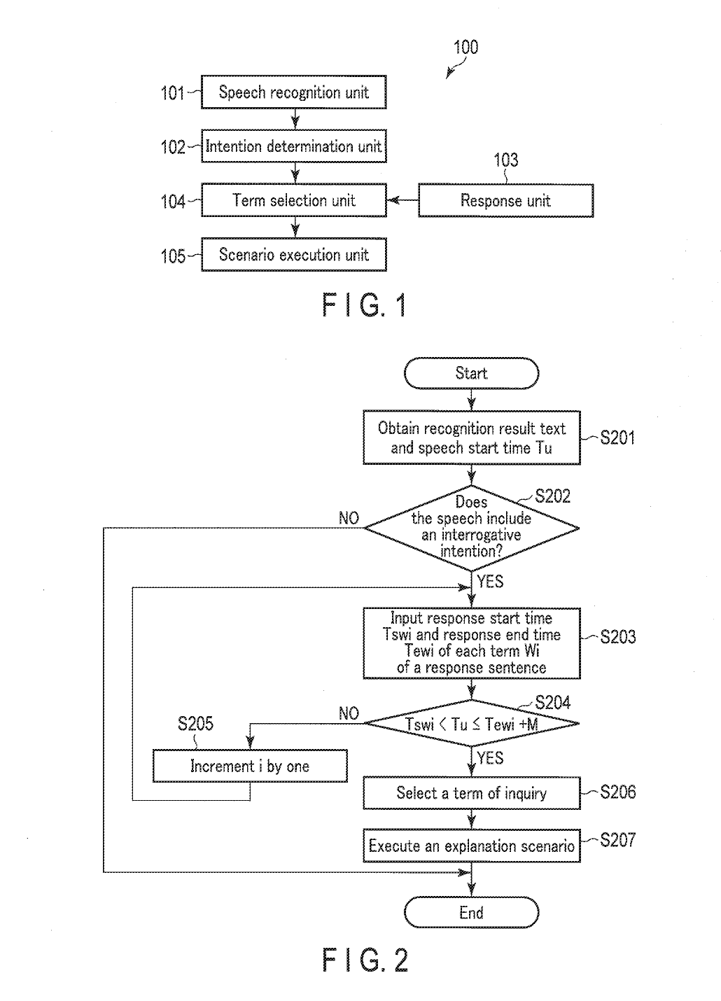

A speech interaction apparatus according to the first embodiment will be described with reference to the block diagram of FIG. 1.

The speech interaction apparatus 100 according to the first embodiment includes a speech recognition unit 101, an intention determination unit 102, a response unit 103, a term selection unit 104, and a scenario execution unit 105.

The speech recognition unit 101 obtains a users speech to a speech collection device, such as a microphone, recognizes the speech, and generates recognition result text, which is a character string obtained as a result of the speech recognition. The speech recognition unit 101 obtains a speech start time and prosody information, in addition to the recognition result text, in such a manner that the speech start time and prosody information are associated with the recognition result text. The speech start time is a time when a speech has started. The prosody information is information on prosody of a speech, and includes information on, for example, an accent and syllable of the recognition result text.

The intention determination unit 102 receives the recognition result text, speech start time, and prosody information from the speech recognition unit 101, and determines whether or not the speech includes an interrogative intention on the basis of the recognition result text. When the recognition result text is a term or phrase which indicates a question, such as: “Eh?”, “What's that?”, “Huh?”, or “Uh?”; the intention determination unit 102 determines that the user's speech includes an interrogative intention. The intention determination unit 102 may use the prosody information in addition to the recognition result text, and may determine that the speech includes an interrogative intention when the speech contains a rising intonation. The intention determination unit 102 may determine that the speech includes an interrogative intention when the recognition result text is a phrase not including a question mark, such as “I don't understand it at all” or “I don't know.” Alternatively, it is possible to store keywords indicating questions in a keyword dictionary in advance, and make a prosody determination unit 102 refer to the keyword dictionary and determine that the user's speech includes an interrogative intention when the recognition result. text corresponds to a keyword.

The response unit 103 interprets the intention of a user's speech, and outputs a response sentence by using an interaction scenario corresponding to the intention. The process of outputting a response sentence at the response unit 103 is a process in a general speech interaction. Thus, the detailed description thereof is omitted. The response unit 103 knows a start time of a response (response start time) and an end time of the response (response end time) for each term in the response sentence.

The term selection unit 104 receives, from the intention determination unit 102, a speech determined as including an interrogative intention and a speech start time, and receives, from the response unit 103, a character string of a response sentence, a response start time of the response sentence, and a response end time of the response sentence. The term selection unit 104 refers to the start time, the character string of the response sentence, the response start time of the response sentence and the response end time of the response sentence, and selects a term of inquiry, which is a subject of the user's question, from the response sentence in accordance with the timing of the speech. determined as including an interrogative intention.

The scenario execution unit 105 receives the term of inquiry from the term selection unit 104 and executes an explanation scenario including an explanation of the term of inquiry. The explanation of the term of inquiry may be extracted from an internal knowledge database (not shown), for example.

Next, an operation of the speech interaction apparatus according to the first embodiment will be described with reference to the flowchart of FIG. 2.

In step S201, the speech recognition unit 101 obtains recognition result text obtained by recognizing a user's speech, and a speech start time Tu.

In step S202, the intention determination unit 102 determines whether or not the speech includes an interrogative intention on the basis of the recognition result text. When the speech includes an interrogative intention, the operation proceeds to step S203. When the speech does not include an interrogative intention, the operation is terminated.

In step S203, the term selection unit 104 obtains response start time Tswᵢ and a response end time Tewᵢ of each term Wᵢ of a response sentence. The subscript i is an integer equal to or greater than zero, and is initially set at zero.

In step S204, the term selection unit 104 determines whether or not the speech start time Tu of the user's speech is later than the response start time Tswᵢ of the term Wᵢ and is within a first period M of the response end time Tewᵢ. Namely, the term selection unit 104 determines whether the speech start time Tu of the user's speech satisfies the condition “Tswᵢ<Tu≦Tewᵢ+M.” The first period M is any margin value equal to or greater than zero, which includes a time from output of a term which a user cannot recognize to the user's response indicating a question. Since the response time varies depending on, for example, a user's age, the speech interaction apparatus 100 may learn a time elapsed before each user responses, and reflect the learning result in the first period M. When the speech start time Tu satisfies the condition, the operation proceeds to step S206, and when the speech start time Tu does not satisfy the condition, the operation proceeds to step S205.

In step S205, i is incremented by one. Then, the operation returns to step S203, and the same steps are repeated.

In step S206, the term selection unit 104 selects the term determined as satisfying the condition in step S204 as a term of inquiry. Due to the processing of steps S204 to S206, a term of inquiry, which is the subject of the user's question, can he selected in accordance with user's timing.

In step S207, the scenario execution unit 105 executes an explanation scenario including an explanation of the term of inquiry. This concludes the operation of the speech interaction apparatus 100 according to the first embodiment.

In steps S203 to S205, terms in a response sentence are subjected to determination processing in the order of appearance for determination of whether or not each term satisfies the condition. However, step S203 may be started from a term in a response sentence that is output a predetermined time before the speech start time of a user's speech. This enables a reduction in processing time, for example, when a response sentence is long.

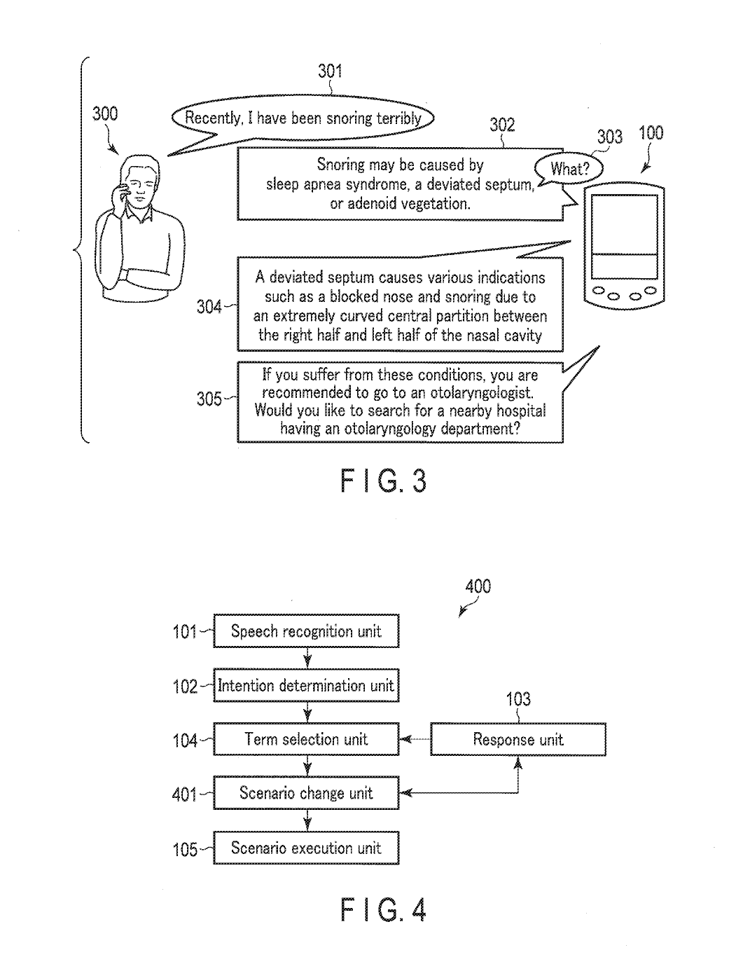

Next, an example of the operation of the speech interaction apparatus 100 according to the first embodiment will be described with reference to FIG. 3.

FIG. 3 shows an example of a speech interaction between a user 300 and the speech interaction apparatus 100. In the example, assumed is a case where an interaction is performed by a user 300 talking with the speech interaction apparatus 100 mounted on a terminal such as a smartphone or a tablet PC. In the example of FIG. 3, a user performs a health consultation.

First, let us assume the case where the user 300 makes a statement 301 “Recently, I have been snoring heavily.” The speech. interaction. apparatus 100 presumes an intention of the statement 301 to he a health consultation by a general intention, estimation method, and executes an interaction scenario for health consultation as a main scenario.

In response to the statement 301, the speech interaction apparatus 100 outputs a response sentence 302 “Heavy snoring may be caused by sleep apnea syndrome, a deviated septum, or adenoid vegetation.”

If the user 300 makes a statement 303 “What?” during the output of the response sentence 302, the speech recognition unit 101 recognizes the user's statement 303, and obtains recognition result text “What?,” prosody information of the statement 303 and a speech start time of the statement 303.

The intention determination unit 102 determines that the statement 303 “What?” includes an interrogative intention. The term selection unit 104 refers to the speech start time of the statement 303, the response start time and response end time of each term in the response sentence 302, and selects a term of inquiry. In this example, the user makes the statement 303 “What?” immediately after the output of the term “deviated septum” in the response sentence 302. The term selection unit 104 determines that the speech start time of the statement 303 is later than the response start time of the term “deviated septum” and is within the first period of the response end time of the term “deviated septum”, and selects the term “deviated septum” as a term of inquiry.

The scenario execution unit 105 suspends the execution of the interaction scenario for health consultation, and executes an explanation scenario for explaining the term of inquiry. Specifically, the speech interaction apparatus 100 outputs a response sentence 304 “A deviated septum causes various indications such as a blocked nose and snoring due to an extremely curved central partition between. the right side and the left side of the nasal cavity.”

After execution of the explanation scenario of response sentence 304, the main interaction scenario for health consultation restarts, and the interaction proceeds. Specifically, the speech interaction apparatus 100 outputs a response sentence 305 “If you suffer from these diseases, you are recommended to go to the otolaryngologist. Would you like to search for a nearby hospital having an otolaryngology department?”

According to the first embodiment described above, when a user does not understand a term in a response sentence in a speech interaction, the user can hear an explanation of the term that the user does not understand only by making a simple statement with an interrogative intention, such as “What?” or “Uh?,” and can understand a difficult term such as a technical term. Consequently, the user can perform a smooth speech interaction.

### Second Embodiment

In the first embodiment, an explanation scenario is always executed after a term of inquiry is selected. However, some users may feel that the explanation of the term of inquiry is unnecessary. In the second embodiment, a response sentence which encourages a user to confirm the term of inquiry is output so that the user can determine whether or not an explanation scenario needs to be executed. Accordingly, a smoother speech interaction which respects the users wishes can be performed.

A speech interaction apparatus according to the second embodiment will be described with reference to the block diagram of FIG. 4.

The speech interaction apparatus 400 according to the second embodiment includes a speech recognition unit 101, an intention determination unit 102, a response unit 103, a term selection unit 104, a scenario execution unit 401, and a scenario change unit 401.

The operations of the speech recognition unit 101, intention determination unit 102, response unit 103, term selection unit 104, and scenario execution unit 105 are the same as those in the first embodiment, and descriptions thereof will be omitted.

The scenario change unit 401 receives a term of inquiry from the term selection unit 104, generates a confirmation sentence to make a user confirm whether or not the term of inquiry should be explained, and instructs the response unit 103 to present the confirmation sentence to the user. The scenario change unit 401 changes the scenario being executed to an explanation scenario upon receipt from the user of an instruction to explain the term of inquiry.

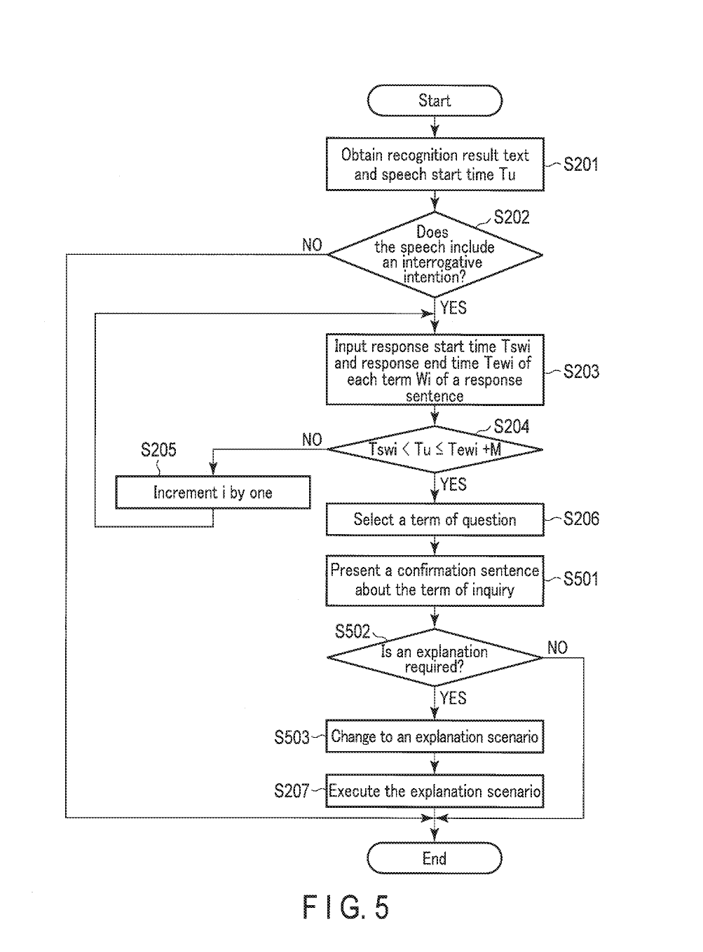

Next, an operation of the speech interaction apparatus 400 according to the second embodiment will be described with reference to the flowchart of FIG. 5. Steps S201 to S207 are the same as those in FIG. 2, and descriptions thereof will be omitted.

In step S501, the scenario change unit 401 generates a confirmation sentence to confirm whether or not the term of inquiry selected in step S206 should be explained, and instructs the response unit 103 to present the confirmation sentence to the user.

In step S502, the scenario change unit 401 determines whether the term of inquiry needs to be explained. To determine whether an explanation is required, for example, the speech recognition unit 101 recognizes a user's speech. When the user replies (speaks) “Yes,” it is determined that an explanation is required. When the user replies (speaks) “No,” it is determined that an explanation is not required. When an explanation is required, the operation proceeds to step S503. When an explanation is not required, the operation is terminated.

In step S503, the scenario change unit 401 changes the scenario being executed to an explanation. scenario. The change of scenario may be made by preparing explanation scenarios in advance, and performing switching from a scenario being executed to an explanation scenario in accordance with a user's instruction. It is also possible to generate an explanation scenario upon receipt of a user's instruction and insert the explanation scenario in a scenario being executed. This concludes the operation of the speech interaction apparatus 400 according to the second embodiment.

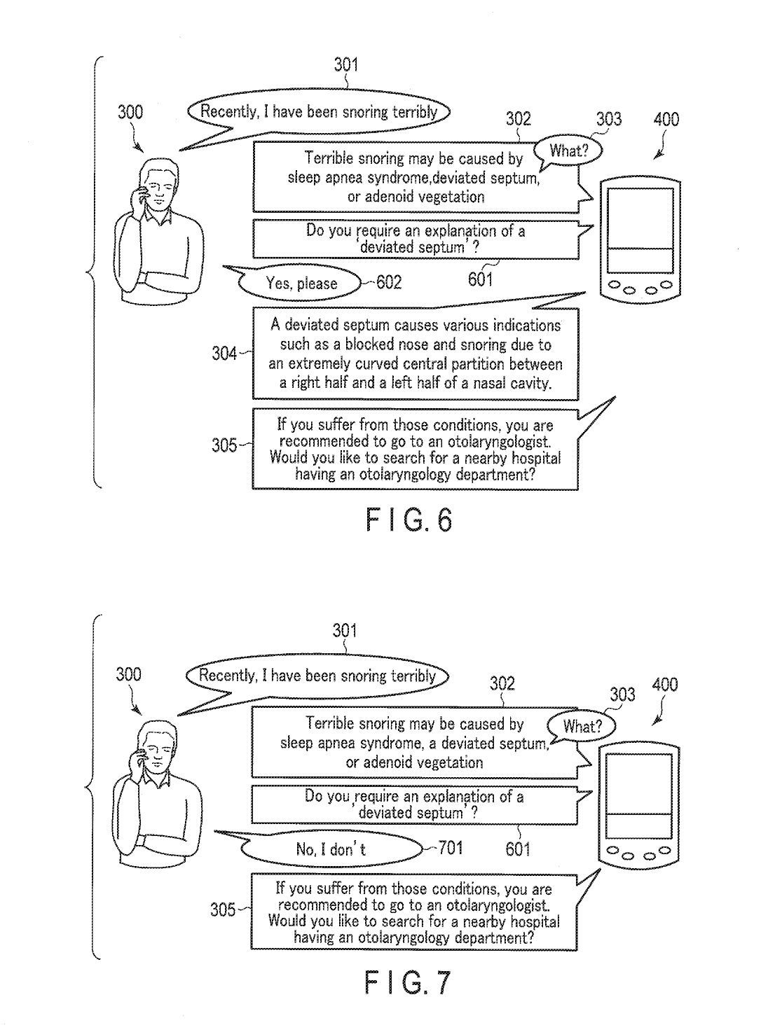

Next, an example of the operation of the speech interaction apparatus 400 according to the second embodiment will be described with reference to FIGS. 6 and 7.

FIG. 6 shows a case where a user requires an explanation. As in the case shown in FIG. 3, let us assume that a user 300 makes a statement 301, the speech interaction apparatus 400 outputs a response sentence 302, and the user makes a statement 303 during the output of the response sentence 302.

When “deviated septum” is selected as a term of inquiry, a response sentence 601 “Do you require an explanation of ‘deviated septum’?” is generated as a confirmation sentence, and presented to the user 300.

When the user 300 makes a statement 602 “Yes, please,” the speech interaction apparatus 400 determines that the user requires an explanation of the term of inquiry, changes the scenario being executed to an explanation scenario, and outputs a response sentence 304 which is an explanation of the term of inquiry.

A case where a user does riot require explanation is shown in FIG. 7. The process until response sentence 601 is output in FIG. 7 is the same as that in FIG. 6.

When the user 300 makes a statement 701 “No, I don't,” after the response sentence 601 is output, the speech interaction apparatus 400 outputs response sentence 305 without changing the scenario being executed to an explanation scenario.

According to the second embodiment described above, a confirmation sentence to confirm whether or not an explanation scenario should be executed is presented to the user. Thus, whether to provide an explanation of a term of inquiry can be determined in accordance with an instruction of the user, and a smoother speech interaction which respects the wishes of the user can be performed.

### Third Embodiment

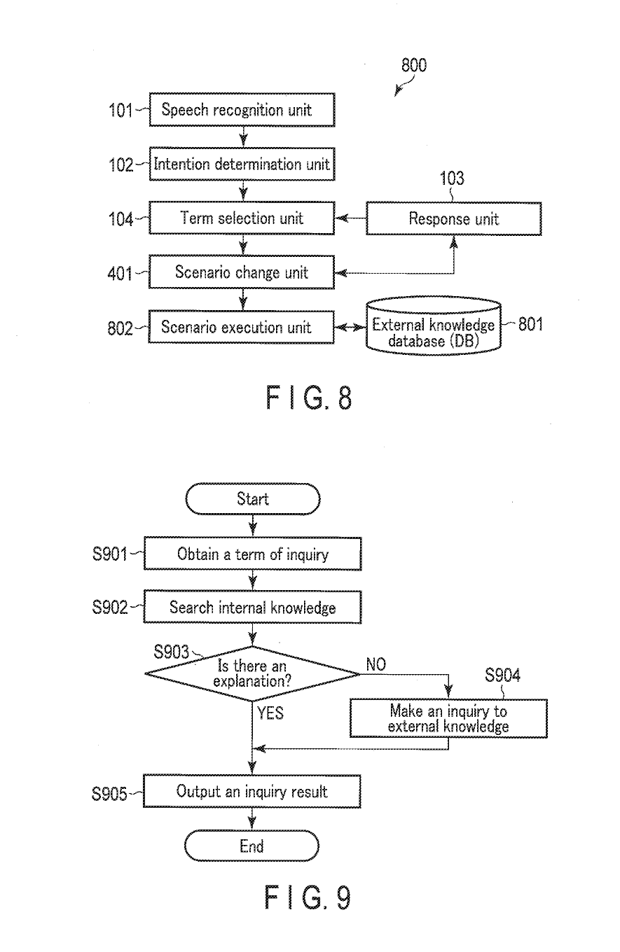

The third embodiment differs from the above embodiments in that an explanation as to a term of inquiry is provided with reference to external knowledge. A speech interaction. apparatus according to the third embodiment will be described with reference to the block diagram of FIG. 8.

The speech interaction apparatus 800 of the third embodiment includes a speech recognition unit 101, an intention determination unit 102, a response unit 103, a term selection unit 104, a scenario change unit 401, an external knowledge database (DB) 801, and a scenario execution unit 802.

The operations of the speech recognition unit 101, intention determination unit 102, response unit 103, term selection unit 104, and scenario change unit 401 are the same as those in the second embodiment, and descriptions thereof will be omitted.

The external knowledge DB 801 stores knowledge of an explanation regarding a term of inquiry, which can be obtained by, for example, an Internet search, and generates an explanation in accordance with an instruction from the scenario execution unit 802 to be described below. The external knowledge DB 801 need not be prepared as a database, and may be configured to obtain an explanation by an Internet search in response to an instruction from the scenario execution unit 802.

When an explanation of a term of inquiry is not within the internal knowledge of the speech interaction apparatus 800, the scenario execution unit 802 makes an inquiry to the external knowledge DB 801. The scenario execution unit 802 receives an explanation as to the term of inquiry from the external knowledge DE 801 and executes an explanation scenario including an explanation of the term of inquiry.

Next, an operation of the scenario execution unit 802 will he described with reference to the flowchart of FIG. 9.

In step S901, the scenario execution unit 802 obtains a term of inquiry.

In step S902, the scenario execution unit 802 searches the internal knowledge for an explanation of the term of inquiry.

In step S903, the scenario execution unit 802 determines whether or not there is an explanation of the term of inquiry. When there is an explanation, the operation proceeds to step S905. When there is not an explanation, the operation proceeds to step S904.

In step S904, the scenario execution unit 802 makes an inquiry to the external knowledge DB 801. Specifically, the scenario execution unit 802 sends an instruction requiring an explanation of the term of inquiry to the external knowledge DB 801. Then, the scenario execution unit 802 obtains the explanation of the term. of inquiry from the external knowledge DB 801, and proceeds to step S905.

In step S905, the scenario execution unit 802 outputs the inquiry result. That is, an explanation scenario including the explanation of the term of inquiry is executed. This concludes the operation of the scenario execution unit 802.

According to the third embodiment described above, an explanation of a term of inquiry provided with reference to external knowledge. Thus, an extensive and detailed explanation can be provided, and a smooth speech. interaction can be performed.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described. herein may be made without departing from the spirit of the inventions. The accompanying claims and their equivalents are intended to cover such forms or modifications as would fall within the scope and spirit of the inventions.

What is claimed is:

1. A speech interact ion apparatus for performing an interaction with a user based on a scenario, the apparatus comprising:
a speech recognition unit that recognizes a speech of the user and generates a recognition result text;
a determination unit that determines whether or not the speech includes an interrogative intention based on the recognition result text;
a selection unit that, when the speech includes the interrogative intention, selects a term of inquiry from a response sentence in the interaction in accordance with timing of the speech, the term of inquiry being a subject of the interrogative intention; and
an execution unit that executes an explanation scenario including an explanation. of the term of inquiry.

2. The apparatus according to claim 1, wherein
the speech recognition unit further obtains a prosody of the speech, and
the determination unit determines whether or not the speech includes the interrogative intention in reference to the recognition result text and the prosody.

3. The apparatus according to claim 1, wherein
the speech recognition. unit further obtains a speech start time of the speech, and
the selection unit selects a term in the response sentence as the term of inquiry when the speech start time is later than a response start time of the term and is within a first period of a response end time of the term.

4. The apparatus according to claim 1, further comprising a change unit that confirms whether or not to provide an explanation of the term of inquiry, and changes a scenario being executed to the explanation scenario when the user makes speech requiring the explanation of the term of inquiry.

5. The apparatus according to claim 4, wherein the explanation scenario is generated after the user makes the speech requiring the explanation of the term of inquiry, and inserted in the scenario being executed.

6. The apparatus according to claim 1, wherein the explanation scenario is an interaction scenario generated in advance.

7. The apparatus according to claim 1, wherein the explanation scenario is different from the scenario.

8. A speech interaction method for performing an interaction with a user based on a scenario, the method comprising:
recognizing a speech of the user and generates a recognition result text;
determining whether or not the speech includes an interrogative intention based on the recognition result text;
selecting a term of inquiry from a response sentence in the interaction in accordance with timing of the speech when the speech includes the interrogative intention, the term of inquiry being a subject of the interrogative intention; and
executing an explanation scenario including an explanation of the term of inquiry.

9. The method according to claim 8, further comprising obtaining a prosody of the speech, and
the determining determines whether or not the speech includes the interrogative intention in reference to the recognition result text and the prosody.

10. The method according to claim 8, further comprising obtaining a speech start time of the speech, and
the selecting the term of inquiry selects a term in the response sentence as the term of inquiry when the speech start time is later than a response start time of the term and is within a first period of a response end time of the term.

11. The method according to claim 8, further comprising confirming whether or not to provide an explanation of the term of inquiry, and changing a scenario being executed to the explanation scenario when the user makes a speech requiring the explanation of the term of inquiry.

12. The method, according to claim 11, wherein the explanation scenario is generated after the user makes the speech requiring the explanation of the term of inquiry, and inserted in the scenario being executed.

13. The method according to claim 8, wherein the explanation scenario is a scenario generated in advance.

14. The method according to claim 8, wherein the explanation scenario is different from the scenario.

15. A non-transitory computer readable medium. including computer executable instructions, wherein the instructions, when executed by a processor, cause the processor to perform a method comprising:
recognizing a speech of the user and generates a recognition result text;
determining whether or not the speech includes an interrogative intention based on the recognition result text;
selecting a term of inquiry from a response sentence in the interaction in accordance with timing of the speech when the speech includes the interrogative intention, the term of inquiry being a subject of the interrogative intention; and
executing an explanation scenario including an explanation of the term of inquiry.

16. The medium according to claim 15, further comprising obtaining a prosody of the speech, and
the determining determines whether or not the speech includes the interrogative intention in reference to the recognition result text and the prosody.

17. The medium according to claim 15, further comprising obtaining a speech start time of the speech, and
the selecting the term of inquiry selects a term in the response sentence as the term of inquiry when the speech start time is later than a response start time of the term and is within a first period of a response end time of the term.

18. The medium according to claim 15, further comprising confirming whether or not to provide an explanation of the term of inquiry, and changing a scenario being executed to the explanation scenario when the user makes a speech requiring the explanation of the term of inquiry.

19. The medium according to claim 18, wherein the explanation scenario is generated after the user makes the speech requiring the explanation of the term of inquiry, and inserted in the scenario being executed.

20. The medium according to claim 15, wherein the explanation scenario is a scenario generated in advance.
